(19) United States
(12) Patent Application Publication
(10) Pub. No.: US 2011/0006049 A1
(43) Pub. Date: Jan. 13, 2011

(54) ROOF HEATER

(76) Inventor: JOHN THOMPSON, JR., EAST ORANGE, NJ (US)

Correspondence Address: Gearhart Law LLC, 41 River Road, Suite 1A, Summit, NJ, 07901, US

(21) Appl. No.: 12/828,320

(22) Filed: Jul. 1, 2010

Related U.S. Application Data
(60) Provisional application No. 61/270,538, filed on Jul. 9, 2009.

(51) Int. Cl. B60L 1/02; H05B 3/34; H05B 3/02

(52) U.S. Cl. 219/202; 219/528; 219/482

(57) ABSTRACT

The invention relates to a portable electrical device for melting snow and ice that has accumulated on the surface of a vehicle. During inclement weather, snow, sleet, rain or hail accumulate on all exposed surfaces of the automobile, in particular on the flat surfaces, such as on the roof, the hood, the trunk, or a truck bed of a vehicle. These areas of snow coverage are relatively large and significantly high off the ground, presenting a challenge to clean in terms of time and effort. Frequently, the owners of the vehicles need to use their automobiles early in the morning, when snow or ice that has accumulated over night is at its hardest. Since it is unsafe, and sometimes unlawful, to operate a vehicle that has not been properly snow dusted and deiced, cleaning must be effectuated before a vehicle can be driven on the roads.

### CLAIM OF PRIORITY

This application claims the priority of U.S. Ser. No. 61/270,538 filed on Jul. 9, 2009, the contents of which are fully incorporated herein by reference.

### FIELD OF THE INVENTION

The invention relates to an automotive accessory device for assistance with clearing snow and ice from a vehicle surface.

### BACKGROUND OF THE INVENTION

The invention relates to a portable electrical device for melting snow and ice that has accumulated on the surface of a vehicle. During inclement weather, snow, sleet, rain or hail accumulate on all exposed surfaces of the automobile, in particular on the flat surfaces, such as on the roof, the hood, the trunk, or a truck bed of a vehicle. These areas of snow coverage are relatively large and significantly high off the ground, presenting a challenge to clean in terms of time and effort. Frequently, the owners of the vehicles need to use their automobiles early in the morning, when snow or ice that has accumulated over night is at its hardest. Since it is unsafe, and sometimes unlawful, to operate a vehicle that has not been properly snow dusted and deiced, cleaning must be effectuated before a vehicle can be driven on the roads.

Although vehicle deicers are generally known in the art, they suffer from a number of shortcomings that the present invention attempts to correct, such as, but not limited to, high cost, challenges in implementation, bulkiness, and complexity of the embodiments. On the contrary, the present invention is not overly large, and yet still able to cover and defrost large segments of an automobile. Due to its portability the present invention affords the ability to be quickly deployed and then to be quickly rolled back up again for storage. A user can leave it on the vehicle in the evening and then power it up in the morning, which can even be done from a distance in an embodiment supporting remote commands.

### DESCRIPTION OF THE RELATED ART

U.S. Pat. No. 4,488,033 discloses a heater assembly for heating a surface such as the rear window of an automobile. A plurality of heater elements are adhesively secured onto the surface in generally vertically spaced horizontally extending direction. A pair of busbars are adhesively secured onto said surface in generally vertically extending direction overlying the heater elements adjacent the opposite ends thereof. End portions of the heater elements which extend beyond the busbars are wrapped around the busbars and firmly retained by a pair of covering members which are secured in juxtaposed relation to the busbars for providing good electrical contact between the heater elements and the busbars.

U.S. Pat. No. 6,696,674 discloses a snow and ice melting system for deicing vehicles having a resistive heating element and a heating layer encasing the resistive heating element. The heating layer is capable of conducting heat and is pliable. A heat dissipation mesh is encased in a heat dissipation layer. The heat dissipation layer is connected to the heating layer. The heat dissipation layer is capable of conducting heat and is pliable.

U.S. Pat. No. 6,963,049 concerns A snow removal system for melting snow from the body of a vehicle is disclosed. The snow removal system includes a control assembly being designed for operationally coupling to a power supply of the vehicle. A plurality of conducting strips are operationally coupled to the control assembly. The conducting strips are designed for being coupled to the body of the vehicle. The control assembly distributes power through the conducting strips whereby the conducting strips generate heat when power is passed through the conducting strips for warming the body of the vehicle to melt snow on the vehicle.

Various implements are known in the art, but fail to address all the problems solved by the invention described herein. One embodiment of this invention is illustrated in the accompanying drawings and will be described in more detail herein below.

### SUMMARY OF THE INVENTION

The present invention discloses a mat having a top surface and a bottom surface, where either or both surfaces can be water proof or transmit heat. The mat incorporates a heating source, and a power source with a power cord to fuel the heating source. The power source may be embodied as a current converter, inverter or a transformer, or a single comprehensive device performing all three functions together. The power cord may derive electric current from a car battery, car alternator or generator, or an external electrical outlet.

The preferred role for the present invention is to defrost ice or snow that has accumulated on the top surfaces of a vehicle, such as a roof. The present invention can be installed on top of the vehicle and remain in place throughout the winter, or can be stored within the trunk of a vehicle when not in use. The light weight, portability and efficiency of the present invention make it a long-awaited, significant and non-obvious improvement over the prior art.

Therefore, the present invention succeeds in conferring the following, and others not mentioned, desirable and useful benefits and objectives.

It is an object of the present invention to provide a mat for melting and clearing ice and snow particularly on exposed surfaces of a vehicle.

It is another object of the present invention is to provide an outdoor or indoor heating mat that encloses a heating source.

Still another object of the present invention is to provide a device which is reasonably small and easy to handle.

Still another object of the present invention is to provide a mat that is made of a freely available material such as rubber.

Yet another object of the present invention is to provide a mat for melting ice and snow, where the heating source is made of a ceramic material.

Still another object of the present invention is to provide an easy to use mat that is powered with a cord connecting to a cigarette lighter, a wall outlet, or having an internal battery.

Still another object of the present invention is to provide a mat that is capable of linking with other mats to form an array of mats for melting and clearing ice or snow from a variety of surfaces and a range of surface areas.

### BRIEF DESCRIPTION OF THE DRAWINGS

FIG. 1 shows a close-up perspective view of the preferred embodiment of present invention, demonstrating the preferred use of the present invention.

FIG. 2 shows a top view of the preferred embodiment.

FIG. 3 shows a side view of the preferred embodiment.

FIG. 4 shows a perspective cross sectional diagram of the present invention, where an outside covering has been peeled away to reveal a section of an internal heating source.

FIG. 5 shows an exploded view of the preferred embodiment of the present invention.

FIG. 6 shows an alternative embodiment of the present invention split into several sections.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

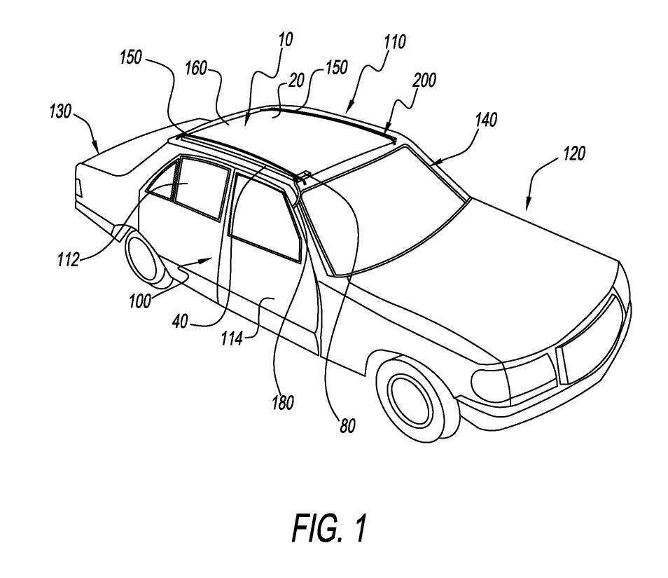

The preferred embodiment is shown in FIG. 1, which discloses a mat 10, a top surface 20, a power source 80, a vehicle 100, a roof 110, edges 115, a hood 120, a trunk 130, a windshield 140, rails 150, fixating holes 160, and fasteners 170, and a power cord 180. The mat 10 will vary with the size of the top surface of a vehicle, but is preferably between 44 and 46 inches in length 50; between 34 and 36 inches in width 60; and between 0.25 and 1/16 inches in thickness 65, with the preferred thickness being 0.056 inches. The thickness 65 may be variable in some embodiments. For example, while the top surface and 20 and bottom surface 30 may be smooth, they may also be textured or patterned. Moreover, the mat 10 may have a geometric pattern on the top surface 20 that helps disperse ice or snow, such as ridged, pyramidal, spiked or other configurations. The mat 10 is designed to substantially cover the roof area of an average passenger vehicle. In a common automobile, the hardest to reach area for snow and ice removal is the vehicle's roof 110. For this reason, the present invention is shown draped over the roof 110, covering most of the roof 110, except for the edges 115 that usually do not tend to get as much accumulation of snow and ice, and are more easily cleared. However, the open area of the edges 115 may happen by circumstance, but is not necessary to enable the present invention, and the mat 10 may even project beyond the roof 110 in especially small vehicles.

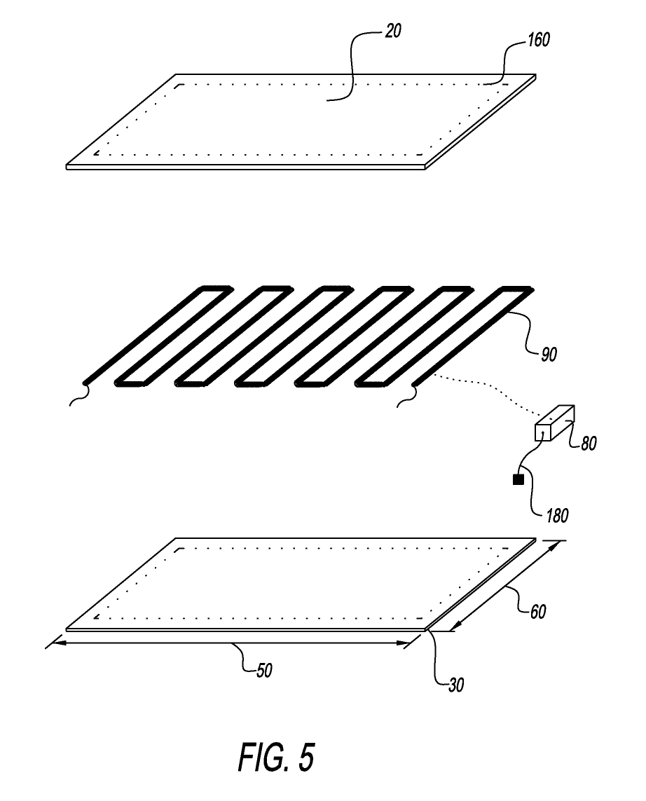

The top surface 20 and the bottom surface 30 of the mat 10 are preferably waterproof and made from insulating, fire resistant material, such as rubber or Teflon, or a polymer, such as plastic. The material used in the construction of the mat 10 must be highly heat resistant, to prevent the mat 10 from overheating and damaging the surface of the vehicle 100. As an aesthetic enhancement, or for promotional purposes, the top surface 20 may contain a logo, a decal, a design, or other promotional material. Both the top surface 20 and the bottom surface 30 (FIG. 5) are preferably good conductors of thermal energy.

Still referring the FIG. 1, shown are rails 150, which may be embodied in a common or specifically customized roof rack that is optional or standard with most vehicles. In an embodiment where rails 150 are in the form of a roof rack, the fasteners 170 would likely be (not shown) in the form of metal strips commonly used with a standard roof rack design having screws and wing nuts or hooks on both ends, or a strip of material with a hook and a loop combination on either end. Such a fastener would hook with one end onto the rails 150, which may make up a roof rack, and with the other end snag one of the fixating holes 160. Alternatively, one of the hooks can be a permanently attached as a loop (not shown) that is either threaded over the rails 150 or within a fixating hole 160. The fixating holes 160 may also be used for screw like fasteners that would be inserted through the fixating holes 160 and then either directly into openings in the roof 110 or in the rails 160. The spacing between the fixating holes should preferably be between 2½ and 2¾ inches.

The primary purpose of the fixating holes 160 and fasteners 170 is to prevent the mat 10 from slipping off the roof 110, either during the flow of the melting process, or under the influence of gravity, if the surface of the vehicle 100 takes on a significantly curved appearance. The fasteners 170 are especially preferred when the present invention is attached to the vehicle 100 and when the vehicle 100 is moving. Since the mat 10 may continue to melt ice and snow while the vehicle is moving, it is important that the mat 10 is securely fastened to the roof 110 with fasteners 170. The fastened mat 10 can also function to prevent large segments of melting snow and ice from flying off the surface of the vehicle 100 in the direction of neighboring vehicles.

The power cord 180 has an adapter to connect to an onboard power outlet or a cigarette lighter, which are powered by the car battery when the engine is turned off. Or by the alternator or an on board direct current generator, when the vehicle 100 is running. The power source 80, shown disposed on the mat 10 with emanating power cord 180, is able to convert the direct current from the battery into alternative current utilized in the present invention or to pass through the alternating current generated by a vehicle's alternator. The power source 80 may have a voltage of 120 volts and a wattage of 1000 watts, and may also function as a transformer, to step up or step down the current necessary to operate the heating source 90. The preferred current range for the present invention is between 9 and 15 amperes, but will vary with the size of the roof heater.

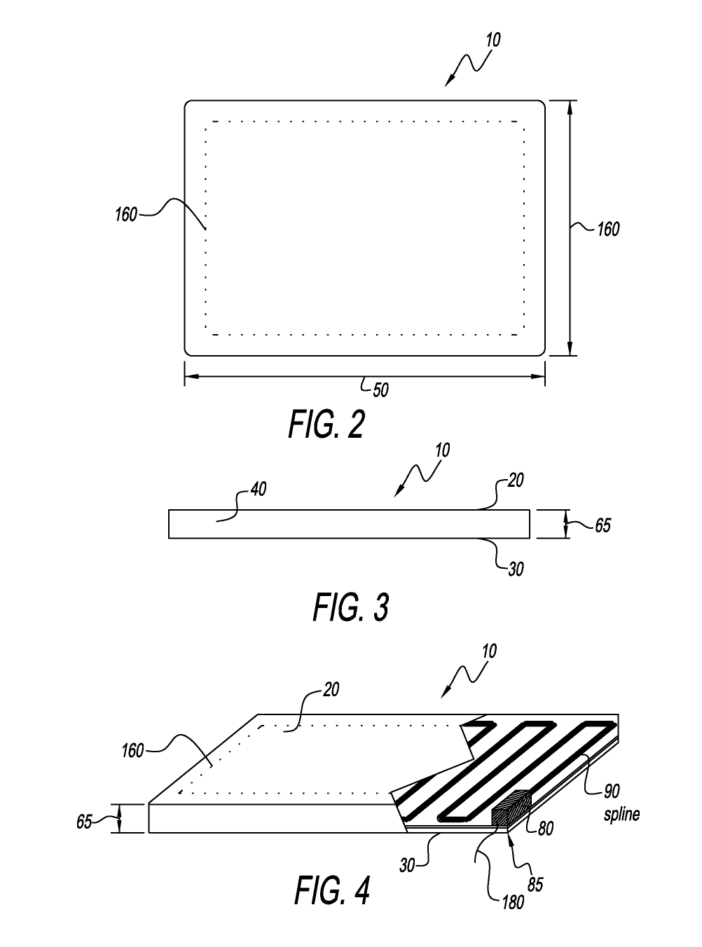

FIGS. 2-5 present different angle views of the present invention, including a cross sectional cutout in FIG. 4. Shown in these FIGS are a mat 10, a top surface 20, a bottom surface 30, a side surface 40, length 50, width 60, thickness 65, a power source 80, a heating source 90, fixating holes 160, and a power cord 180. The heating source 90 is preferably a coil molded into the mat in a design of a sine curve. The heating source 90 may also be a series of parallel, diagonal or perpendicular rods emanating from a side stem or from a central stem (not shown), or a combination of heating rods and heating coils. More or fewer coils will cause the roof heater to heat slower or faster, respectively.

To heat quickly while using the least amount of energy, the present invention applies ceramics, preferably screen printed unto a steel wire, but other forms of ceramic disposition may be used. The preferred type of ceramic material is one possessing a positive thermal coefficient such as barium Titania or lead Titania composites. However, the heating source 90 may also be made from any other material having high resistance to electrical current, such as, but not limited to, Kanthal, Nichrome or Cupronickel. The heating source 90 is preferably molded into the mat 10 between the top surface 20 and the bottom surface 30. In other embodiments of the present invention may feature removable or free-floating heating source 90. Additional, insulating or thermal layers may be incorporated. However, one of the aims is to prevent the present invention from becoming overly bulky, heavy or expensive. The heating source 90 is able to generate the temperatures between 32 and 50 degrees C./F. on the top surface 20 or bottom surface 30.

The thickness of the present invention is disclosed in FIG. 1 above. The sidewall 40 may incorporate a reinforcing element, such as a rod made out of fabric, plastic, rubber or metallic wire. Such a reinforcing element will provide lateral support for the fixating holes 160, and prevent the fasteners 170 from tearing through the side of the fixating holes 160.

The power source 80 is shown on the right corner 85 of the mat 10. It may also be disposed anywhere else on the mat 10, or along the power cord 180 and separate from the mat 10. The power source 80 may additionally have sockets or connectors to link to other mats 10, and thus create a larger embodiment of the present invention. Such sockets or connectors may be disposed separately from the power source 80. In a multi-section embodiment, each mat 10 would preferably contain its own power source 80, so that each can be used independently in addition to being powered by a common power source 80, when linked together. An ability to connect multiple mats 10 together to form an array, adds a great deal of flexibility, leading to diverse applications of the present invention, such as melting snow in driveways, parking spots, side walks, etc.

In another embodiment of the present invention, the vehicle may contain a specialized socket or outlet to accept an equivalently adapted connector on the mat 10. Such connectors may be embodied in a set of exposed wire ends or metallic plates on the surface of the vehicle that correspond to an equivalent set of metallic plates, hooks, or ends of a wire on the mat 10. Such connection would enable a more permanent or prolonged installation of the mat 10 and obviate the need to keep the windows 112 or doors 114 ajar to accommodate the power cable 180.

While the invention has been shown and illustrated as an after market product, in another embodiment the mat 10 is installed on new vehicles at the factory. Mat 10, for example, could be designed and built directly into the vehicle, located within the roof or hood.

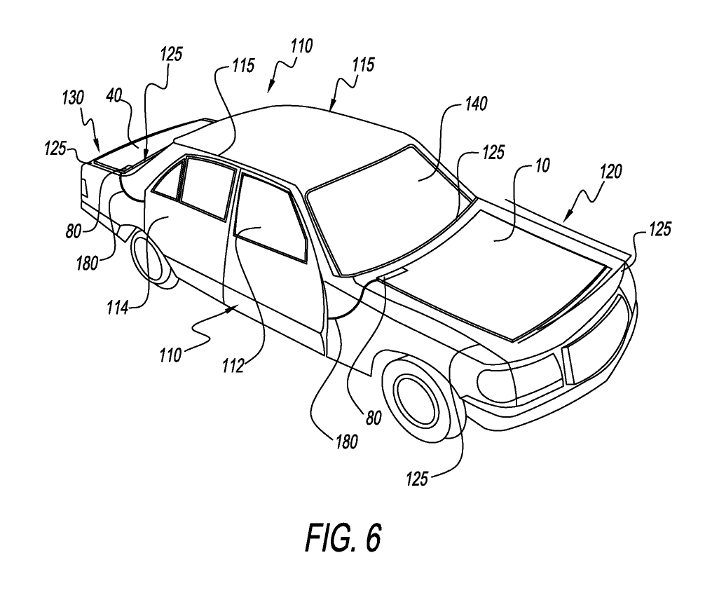

FIG. 6 discloses the mat 10 being used on surfaces of the vehicle 100 other than the roof 110. Shown in this FIG. are two mats 10, power sources 80, a vehicle 100, a roof 110, windows 112, doors 114, a hood 120, a trunk 130, a windshield 140, fixating holes 160, and power cords 180. The mat 10 may be adapted to clear any vehicle surface from snow or ice. On these surfaces, the mat 10 may be secured with fasteners 170 that latch onto lips 125 or edges 115 of the roof 110, or use straps with fasteners on both ends (not shown) to connect to rails 150, if such are present. The mat 10 may also be used on the glass surfaces of the present invention, such as on the windshield 140. When multiple mats 10 are used, the power cords 180 may either embody a linking feature, so as to use a common onboard power outlet, or a cigarette lighter. Alternatively, on mat 10 may be connected to an onboard power outlet, while the other mat 10 may be connected to an external electrical outlet, either directly or through an adapter. The preferred voltage range for an external electrical outlet should be 120 V, but may also embody other voltage ranges.

The mat 10 is preferably a vehicle accessory and may be rolled up or folded and stored in the trunk until needed, or permanently installed on the vehicle 100, or installed for the duration of the winter season. A storage pouch (not shown) may be adopted for specific vehicles or storage areas within vehicles or structures or as a stand alone object. One method of using the present invention is for a user to install the mat 10 unto the surface of the vehicle 100 in anticipation of inclement weather, or during an ongoing storm. Then retire inside a residence for the night, or for a period of time, or until the weather clears. No matter how used, the mat 10 will keep itself and its supporting surface heated and clear of snow and ice.

The heating source 90 within the mat 10 may be activated by a timer switch that may be provided with the power source 80, or the mat 10 may be remotely activated, if the power source 80 is able to respond to commands received by a receiver of infrared, radio wave or other type of electromagnetic radiation issued by a remote control device widely implemented in the remote control industry. However, it may be preferred the mat 10 may be activated automatically as soon as the vehicle 100 is powered on. Once the snow or ice is melted, a user may drive with the mat 10 still on the vehicle 100, or preferably take off the mat 10, roll it up or fold it, and store inside the trunk 130, or in some other location.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. An article of manufacture, comprising:
a mat having a top surface and a length at least 46 inches and a width of 36 inches,
wherein the mat has a heating source disposed therein; and
a power source for heating the heating source.

2. The article of claim 1, wherein the heat source are heating coils.

3. The article of claim 1, wherein the mat is a rubber mat.

4. The article of claim 2, wherein the heat source is molded into the mat.

5. The article of claim 1, wherein the heat coils are ceramic.

6. The article of claim 1, wherein the power source is between 5 and 15 amps.

7. The article of claim 1, wherein the mat is held on a vehicle with a rack.

8. The article of claim 1, wherein the article can variably maintain the top surface of the mat at a temperature of from 32 to 50 degrees.

9. The article of claim 1, wherein the power source receives power from a cigarette lighter.

10. The article of claim 1, wherein the power source receives power from a 120 volt outlet.

11. The article of claim 1, wherein the mat contains additional layers.

12. The article of claim 1, wherein the mat further comprises a connector, wherein said connected links multiple said mats together in an array.

13. The article of claim 1, wherein said power source is capable of receiving and responding to remote commands.

14. An article of manufacture, comprising:
a rubber mat having a top surface and a bottom surface;
a continuous length of ceramic heating coils disposed within the mat; and
a power source that applies current to the heating coils.

15. The article of claim 14, wherein the article can variably maintain the top surface of the mat at a temperature of from 32 to 50 degrees.

16. The article of claim 14, wherein the mat is held on a vehicle with a rack.

17. The article of claim 14, wherein the mat is attached to a vehicle with fasteners.

18. The article of claim 14, wherein the article can variably maintain the top surface of the mat at a temperature of from 32 to 50 degrees.

19. The article of claim 14, wherein the power source receives power from a cigarette lighter.

20. The article of claim 14, wherein the power source receives power from a 120 volt outlet.

21. The article of claim 14, wherein the mat further comprises a connector, wherein said connected links multiple said mats together in an array.

22. The article of claim 14, wherein said power source is capable of receiving and responding to remote commands.
